(19) United States
(12) Patent Application Publication
(10) Pub. No.: US 2006/0240264 A1
(43) Pub. Date: Oct. 26, 2006

(54) N-methylpyrrolidone-free polyurethane dispersions based on dimethylolpropionic acid

(75) Inventors: Rolf Gertzmann, Leverkusen (DE); Erhard Luhmann, Bomlitz (DE); Richard Kopp, Koln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/408,233

(22) Filed: Apr. 20, 2006

(30) Foreign Application Priority Data
Apr. 25, 2005 (DE) 102005019430.3

(51) Int. Cl. C08G 18/00

(52) U.S. Cl. 428/423.1; 528/44

(57) ABSTRACT

The present invention relates to aqueous polyurethane dispersions that are free from N-methylpyrrolidone and other solvents and wherein the polyurethanes are the reaction products of A) a mixture of 25% to 90% by weight of 1-isocyanate-3,3,5,-trimethyl-5-isocyanatomethylcyclohexane (IPDI) and 10% to 75% by weight of 4,4′-diisocyanatodicyclohexylmethane, wherein the preceding percentages are based on the weight of component A), with B) one or more polyols having average molarcular weights (Mn) of 500 to 6000, C) one or more compounds which have at least one OH— or NH-functional group and contain a carboxyl and/or carboxylate group, wherein at least 50 mol % of the acid groups, based on the total moles of acid incorporated into the polyurethane, are incorporated by dimethylolpropionic acid, D) one or more polyols and/or polyamines having average molecular weights (Mn) of below 500, and E) optionally one or more monoalcohols and/or monoamines. The present invention also relates to a process for preparing the aqueous polyurethane dispersions and to the use of the polyurethane dispersions for preparing coatings or adhesives.

### BACKGROUND OF THE INVENTION

1. Field of the Invention

The present invention relates to aqueous polyurethane dispersions which contain dimethylolpropionic acid as the hydrophilic agent and are prepared without using N-methylpyrrolidone, and to their use as coating compositions having high resistance properties.

2. Description of Related Art

With the objective of lowering the emissions of organic solvents, aqueous coating compositions are increasingly being used in place of solventborne systems. One important class of aqueous coating binders are the polyurethane dispersions. Polyurethane dispersions display the advantage of uniting important properties such as resistance to chemicals and to mechanical loading. Especially in the area of coated surfaces exposed to severe mechanical stress, the use of polyurethane dispersions is an advantage.

In polyurethane dispersions (PUD) dimethylolpropanoic acid (DMPA), a high-melting compound having poor solubility properties, is frequently used as a hydrophilic component. However, acetone, which is frequently employed in the preparation of the PUD's, is unable to dissolve DMPA sufficiently and as a result the hydrophilic agent is inadequately incorporated into the polymer backbone. The resulting dispersions exhibit inadequate storage stability. Therefore, DMPA is used in conjunction with N-methylpyrrolidone (NMP) as the solvent for DMPA-containing polyurethanes.

Recent investigations into the toxicology of NMP have shown that NMP is to be classed as a toxic substance.

It is therefore an object of the present invention to provide NMP-free and solvent-free polyurethane dispersions which contain DMPA as hydrophilic agent, are storage stable at 40° C. for more than 8 weeks and, with the aid where appropriate only of coalescence assistants, provide transparent, glossy coatings having good resistance properties with respect to discoloration.

DE-A 40 17 525 discloses aqueous polyurethane preparations in which an isocyanate mixture is used containing diisocyanates having no lateral alkyl groups and diisocyanates having at least one lateral alkyl group. In the examples, a mixture of 1-isocyanato-3,3,5-trimethyl-5-isocyanatomethylcyclohexane and 4,4′-diisocyanatodicyclohexylmethane is used to prepare the polyurethane. The ionic compound used is N-(2-aminoethyl)-2-aminoethanecarboxylic acid, present in the form of an aqueous solution. It is added only after the prepolymer preparation, with the dispersing water, for final chain extension and hydrophilic modification. Such a procedure, however, is not possible with DMPA.

De-A 10 221 220 describes polyurethane preparations which certain 10 to 60% by weight of a polyurethane and produce coatings with reduced gloss. The polyurethane is composed of organic isocyanates without any lateral alkyl groups. R is also possible to use organic isocyanates with lateral alkyl groups. The dispersions used for producing the polyurethane preparations are very coarsely divided and also do not have the required stability in storage.

It has now been found that by using a mixture of isocyanates containing 1-isocyanato-3,3,5,-trimethyl-5-isocyanatomethylcyclohexane (IPDI) and 4,4′-diisocyanatodicyclohexylmethane in a defined ratio to one another for the synthesis of the polyurethane based on DMPA, storage-stable products having the aforementioned qualities are obtained.

### SUMMARY OF THE INVENTION

The present invention relates to aqueous polyurethane dispersions that are free from N-methylpyrrolidone and other solvents and wherein the polyurethanes are the reaction products of
A) a mixture of 25% to 90% by weight of 1-isocyanate-3,3,5,-trimethyl-5-isocyanatomethylcyclohexane (IPDI) and 10% to 75% by weight of 4,4′-diisocyanatodicyclohexylmethane, wherein the preceding percentages are based on the weight of component A), with
B) one or more polyols having average molarcular weights (Mn) of 500 to 3000,
C) one or more compounds which have at least one OH— or NH-functional group and contain a carboxyl and/or carboxylate group, wherein at least 50 mol % of the acid groups, based on the total moles of acid incorporated into the polyurethane, are incorporated by dimethylolpropionic acid,
D) one or more polyols and/or polyamines having average molecular weights (Mn) of below 500, and
E) optionally one or more monoalcohols and/or monoamines.

The present invention also relates to a process for preparing the aqueous polyurethane dispersions by i) reacting components (B), (C), (D) and optionally (E), separately in any order or as a mixture, with component (A), to form a prepolymer, which is present as a solution in a solvent, ii) neutralizing component C), before, during or after the prepolymer is dispersed in water, and iii) dispersing the prepolymer in water and removing the solvent by distillation.

The present invention also relates to the use of the polyurethane dispersions for preparing coatings or adhesives.

In a further embodiment of the present invention the polyurethane dispersions also contain polyester(meth)arylates F) and also one or more photoinitiators G).

The polyurethane polymer particles of the polyurethane dispersions of the invention have particle sizes of ≦120 nm, preferably ≦100 nm and more preferably ≦80 nm.

### DETAILED DESCRIPTION OF THE INVENTION

The polyurethane dispersions of the invention contain 5% to 60%, preferably 15% to 57%, and more preferably 25% to 55% by weight of component (A); 0.5% to 65%, preferably 2% to 55% and more preferably 5% to 50% by weight of component (B); 0.5% to 15%, preferably from 2% to 14% and more preferably from 4% to 12% by weight of component (C); 0.5% to 18%, preferably from 2% to 12% and more preferably from 4% to 10% by weight of component (D); and 0 to 10%, preferably from 0 to 7% and more preferably from 0 to 2% by weight of component (E), wherein the percentages are based on the weight of resin solids and add up to 100% by weight, based on the weight of components (A)-(E).

In another embodiment the polyurethane dispersion of the invention contains 5% to 60%, preferably 15% to 57% and more preferably 25% to 55% by weight of component (A); 0.5% to 65%, preferably 2% to 55% and more preferably 5% to 50% by weight of component (B); 0.5% to 15%, preferably from 2% to 14% and more preferably from 4% to 12% by weight of component (C); 0.5 to 18%, preferably from 2% to 12% and more preferably from 4% to 10% by weight of component (D); 0 to 10%, preferably from 0 to 7% and more preferably from 0 to 2% by weight of component (E); 0.5% to 15%, preferably from 2% to 12% and more preferably from 4% to 10% by weight of component (F); and 0.1 to 10%, preferably 0.5% to 7% and more preferably from 0.8% to 5% by weight of component (G), wherein the percentages are based on the weight of resin solids and adding up to 100% by weight, based on the weight of components (A)-(G).

Component (A) contains a mixture of 1-isocyanato-3,3,5-trimethyl-5-isocyanatomethylcyclohexane(isophorone diisocyanate, IPDI) and 4,4′-diisocyanatodicyclohexylmethane in a weight ratio of 25% to 90%, preferably 35% to 80% and more preferably from 45% to 70% by weight of IPDI and 10% to 75%, preferably 65% to 20% and more preferably from 55% to 30% by weight of 4,4′-diisocyanatodicyclohexylmethane.

It is possible to use up to 5% by weight, based on the solid polyurethane resin, of isocyanates having a functionality of three and/or more in order to provide a certain degree of branching or crosslinking in the polyurethane. Isocyanates of this kind may be obtained, for example, by reacting divalent isocyanates with one another such that some of their isocyanate groups are derivatized to isocyanurate, biuret, allophanate, uretdione or carbodiimide groups. Polyisocyanates of this type, which are rendered hydrophilic with ionic groups, are also suitable. Such polyisocyanates may have high functionalities, of more than 3.

Suitable polymeric polyols (B) have a number average molecular weight of from 500 to 3000, preferably from 500 to 2500 and more preferably from 650 to 2000 and are selected from the polyols known for preparing polyurethanes. They have an OH functionality of 1.8 to 5, preferably 1.9 to 3 and more preferably 1.9 to 2.0. They include polyesters, polyethers, polycarbonates, polyestercarbonates, polyacetals, polyolefins, polyacrylates and polysiloxanes. Preferred are polyesters, polyethers, polyester carbonates and polycarbonates. Particularly preferred are difunctional polyester carbonates and polycarbonates. Mixtures of polyesters and polycarbonates are also particularly preferred as polymeric polyols (B).

Component (C) contains at least 50 mol %, based on the total moles of acid introduced into the polyurethane resin, of dimethylolpropionic acid. It is possible to use low molecular weight (Mₙ<300 g/mol) carboxyl-containing compounds having at least one up to a maximum of 3 OH groups. Examples include dimethylolbutyric acid, hydroxypivalic acid, N-(2-aminoethyl)-2-aminoethanecarboxylic acid and also reaction products of (meth)acrylic acid and polyamines (see, for example, DE-A-19 750 186, p. 2,11. 52-57). It is preferred to use dimethylolpropionic acid as the sole hydrophilic component (C).

Suitable components (D) include polyols, amino polyols or polyamines having a number average molecular weight of below 500, which can be used as chain extenders, such as ethanediol, 1,2- and 1,3-propanediol, 1,2-, 1,3- and 1,4-butanediol, 1,5-pentanediol, 1,6-hexanediol, neopentyl glycol, cyclohexane-1,4-dimethanol, 1,2- and 1,4-cyclohexanediol, 2-ethyl-2-butylpropanediol, diols containing ether oxygen (such as diethylene glycol, triethylene glycol, tetraethylene glycol, dipropylene glycol, tripropylene glycol, and polyethylene, polypropylene or polybutylene glycols), trimethylolpropane, glycerol, hydrazine, ethylenediamine, 1,4-diaminobutane, isophoronediamine, 4,4′-diaminodicyclohexylmethane, diethylenetriamine, triethylenetetramine and N-methyldiethanolamine. Preferred as component D) are 1,4-butanediol, 1,6-hexanediol, neopentyl glycol, cyclohexane-1,4-dimethanol, 1,4-cyclohexanediol, trimethylolpropane, ethylenediamine, 1,4-diaminobutane, isophoronediamine and diethylenetriamine.

Besides the use of isocyanate-reactive, polyfunctional compounds, it is also possible to terminate the polyurethane prepolymer with monofunctional alcohols or amines (E). Suitable compounds (E) include aliphatic monoalcohols and/or monoamines having 1 to 18 carbon atoms, such as ethanol, 1-propanol, 2-propanol, n-butanol, secondary butanol, n-hexanol and its isomers, 2-ethylhexyl alcohol, ethylene glycol monomethyl ether, diethylene glycol monomethyl ether, ethylene glycol monobutyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 1-octanol, 1-dodecanol, 1-hexadecanol, lauryl alcohol and stearyl alcohol, butylamine, propylamine, aminoethanol, aminopropanol, diethanolamine or dibutylamine. Preferred are ethanol, n-butanol, ethylene glycol monobutyl ether, 2-ethylhexanol, 1-octanol, 1-dodecanol, 1-hexadecanol, butylamine, propylamine, aminoethanol, dimethylethanolamine, aminopropanol, diethanolamine or dibutylamine. Particular preferred are n-butanol and ethylene glycol monobutyl ether.

Suitable (meth)acrylate-functional binders F) are those which contain acrylic ester and/or methacrylic ester units. When components F) are used as part of the polyurethane dispersion of the invention, they can then be used as a radiation-curable component in coatings.

Suitable acrylate-functional binders F) are esters of acrylic acid or methacrylic acid, preferably acrylic acid, with monofunctional or polyfunctional alcohols. These esters are inert to NCO groups. Examples of suitable alcohols include the isomeric butanols, pentanols, hexanols, heptanols, octanols, nonanols and decanols, and also cycloaliphatic alcohols (such as isoborneol, cyclohexanol, alkylated cyclohexanols and dicyclopentanol), arylaliphatic alcohols (such as phenoxyethanol and nonylphenylethanol), and tetrahydrofurfuryl alcohols. Additionally it is possible for alkoxylated derivatives of these alcohols to be used.

Examples of suitable dihydric alcohols include ethylene glycol, propane-1,2-diol, propane-1,3-diol, diethylene glycol, dipropylene glycol, the isomeric butanediols, neopentyl glycol, hexane-1,6-diol, 2-ethylhexanediol, tripropylene glycol and alkoxylated derivatives of these alcohols. Prefered dihydric alcohols include hexane-1,6-diol, dipropylene glycol and tripropylene glycol. Suitable trihydric alcohols include glycerol or trimethylolpropane or their alkoxylated derivatives. Tetrahydric alcohols include pentaerythritol, ditrimethylolpropane or their alkoxylated derivatives

Preferred NCO-inert, acrylate-functional binders F) are hexanediol diacrylate, tetraethylene glycol diacrylate, dipropylene glycol diacrylate, tripropylene glycol diacrylate, trimethylolpropane triacrylate, trimethylolpropane ethoxytriacrylate, dimethylolpropane tetraacrylate, pentaerythritol tetraacrylate, dipentaerythritol hexaacrylate and ditrimethylolpropane tetraacrylate.

Preferred are hydroxyl-containing polyester(meth)acrylates having an OH content of 30 to 300 mg KOH/g, preferably 60 to 130 mg KOH/g. For the preparation of the hydroxy-functional polyester(meth)acrylates (F) there are a total of 7 groups of monomer constituents that may be employed:
1. (Cyclo)alkanediols (i.e. dihydric alcohols having (cyclo)aliphatically bound hydroxyl groups) having a molecular weight of 62 to 286, such as ethanediol, 1,2- and 1,3-propanediol, 1,2-, 1,3- and 1,4-butanediol, 1,5-pentanediol, 1,6-hexanediol, neopentyl glycol, cyclohexane-1,4-dimethanol, 1,2- and 1,4-cyclohexanediol, 2-ethyl-2-butylpropanediol, diols containing ether oxygen (such as diethylene glycol, triethylene glycol, tetraethylene glycol, dipropylene glycol, tripropylene glycol). Also suitable are polyethylene, polypropylene or polybutylene glycols having a number average molecular weight of 200 to 4000, preferably 300 to 2000, and more preferably of 450 to 1200. Reaction products of the aforementioned diols with ε-caprolactone or other lactones may also be used.
2. Alcohols with a hydroxyl functionality of three or more and having a molecular weight of 92 to 254, such as glycerol, trimethylolpropane, pentaerythritol, dipentaerythritol and sorbitol or polyethers prepared starting from these alcohols, such as the reaction product of 1 mole of trimethylolpropane with 4 moles of ethylene oxide.
3. Monoalcohols such as ethanol, 1- and 2-propanol, 1- and 2-butanol, 1-hexanol, 2-ethylhexanol, cyclohexanol or benzyl alcohol.
4. Dicarboxylic acids having a number average molecular weight of 104 to 600 and/or their anhydrides, such as phthalic acid, phthalic anhydride, isophthalic acid, tetrahydrophthalic acid, tetrahydrophthalic anhydride, hexahydrophthalic acid, hexahydrophthalic anhydride, cyclohexanedicarboxylic acid, maleic anhydride, fumaric acid, malonic acid, succinic acid, succinic anhydride, glutaric acid, adipic acid, pimelic acid, suberic acid, sebacic acid, dodecanedioic acid or hydrogenated dimer fatty acids.
5. Higher functional carboxylic acids and/or their anhydrides, such as trimellitic acid and trimellitic anhydride.
6. Monocarboxylic acids such as benzoic acid, cyclohexane carboxylic acid, 2-ethylhexanoic acid, caproic acid, caprylic acid, capric acid, lauric acid, and natural and synthetic fatty acids.
7. Acrylic acid, methacrylic acid and/or dimeric acrylic acid.

The hydroxyl-containing polyester(meth)acrylates preferably contain the reaction product of at least one constituent from group 1 and/or 2 with at least one constituent from group 4 and/or 5 and at least one constituent from group 7.

In addition it is possible, after the esterification, to react some of carboxyl groups, preferably those from (meth)acrylic acid, with mono-, di- or polyepoxides. Preferred epoxides include the epoxides (glycidyl ethers) of monomeric, oligomeric or polymeric bisphenol A, bisphenol F, hexanediol and/or butanediol or their ethoxylated and/or propoxylated derivatives. This reaction can be used in particular to increase the OH number of the polyester(meth)acrylate, since the epoxide/acid reaction produces in each case one OH group. The acid number of the resulting product is 0 to 20 mg KOH/g, preferably 0 to 10 mg KOH/g and more preferably 0 to 5 mg KOH/g.

Alternatively, it is possible to use the known hydroxyl-containing epoxy(meth)acrylates, hydroxyl-containing polyether(meth)acrylates or hydroxyl-containing polyurethane(meth)acrylates having OH contents of 20 to 300 mg KOH/g and also mixtures thereof with one another, mixtures with hydroxyl-containing unsaturated polyesters, mixtures with polyester(meth)acrylates, or mixtures of hydroxyl-containing unsaturated polyesters with polyester(meth)acrylates. Hydroxyl-containing epoxy(meth)acrylates are preferably prepared from epoxides(glycidyl ethers) of monomeric, oligomeric or polymeric bisphenol A, bisphenol F, hexanediol and/or butanediol and/or their ethoxylated and/or propoxylated derivatives.

Also suitable as component (F) are monohydroxy-functional esters of acrylic and/or methacrylic acid. Examples of such compounds are the mono(meth)acrylates of dihydric alcohols such as ethanediol, oligomeric ethylene glycol with Mₙ<300 g/mol, the isomeric propanediols, oligomeric propylene glycol with Mₙ<350 g/mol, oligomreic ethylene-propylene glycols with Mₙ<370 g/mol and butanediols; or (meth)acrylates of polyhydric alcohols such as trimethylolpropane, glycerol and pentaerythritol that contain on average one free hydroxyl group. Dispersions which comprise unsaturated (meth)acrylates are suitable for crosslinking using high-energy radiation, preferably using UV radiation.

Examples of suitable photoinitiators (G) include aromatic ketone compounds such as benzophenones, alkylbenzophenones, 4,4′-bis(dimethylamino)benzophenone (known as Michler's ketone), anthrone and halogenated benzophenones. Also suitable are acylphosphine oxides such as 2,4,6-trimethylbenzoyl-diphenylphosphine oxide, phenylglyoxylic esters, anthraquinone and its derivatives, benzil ketals and hydroxyalkylphenones. Preferred photoinitiators G) for transparent coating compositions are benzophenones, and for pigmented coating compositions are acylphosphine oxides. Mixtures of these compounds can also be used.

The aqueous polyurethane dispersions are prepared by i) reacting components (B), (C), (D) and, optionally, (E), separately in any order or as a mixture, with component (A), to form a prepolymer, which is preferably present as a solution in a solvent at a solids content 99% to 65%, more preferably 95% to 70% and very preferably 90% to 80% by weight, ii) neutralizing component C), before, during or after the prepolymer is dispersed in water, and iii) dispersing the prepolymer in water and removing the solvents by distillation. Amino-functional components (E) are ideally added only when the reactivity to isocyanates is moderate and it does not lead to the gelling of the batch. Component (A) and also one or more of components (B)-(E) can be introduced as part of the initial charge. Preferably component (A) is used as an initial charge and components (B)-(E) are metered in and reacted with component (A).

The solvents used for the preparation of the polyurethane dispersions are highly volatile components having boiling points below 100° C., which are subsequently removed from the dispersion by distillation. Suitable solvents include acetone, methyl ethyl ketone, tetrahydrofuran and tert-butyl methyl ether, preferably acetone.

“Solvent-free” according to the present application means that ≦0.9% by weight, preferably ≦0.5% by weight and particularly preferably ≦0.3% by weight of solvent remains in the dispersions.

After the reaction of components A)-E), preferably components F) that are unreactive to isocyanates are added to the resulting prepolymer before or after the neutralization of component C), but before dispersing the prepolymer in water. Components F) containing OH groups are added together with components B)-E), to ensure that they are incorporated into polyurethane backbone. With the metering of component F) the known polymerization inhibitors, such as 2,6-di-tert-butyl-4-methylphenol, may optionally be added to prevent premature polymerization of the unsaturated groups.

Suitable neutralizing agents are alkaline organic and/or alkaline inorganic compounds. Based aqueous ammonia solutions, ethylamine solutions and dimethylamine solutions, preferred are volatile primary, secondary and tertiary amines (such as dimethylethanolamine, morpholine, N-methylmorpholine, piperidine, diethanolamine, triethanolamine, diisopropylamine, 2-amino-2-methylpropanol and 2-N,N-dimethylamino-2-methylpropanol) or mixtures of these compounds. Particularly preferred are tertiary amines which are unreactive to isocyanates (such as triethylamine, diisopropylethylamine, N-methylmorpholine, and mixtures of these tertiary amines), which are preferably added to the prepolymer prior to dispersing.

Depending on degree of neutralization the dispersion may contain very fine particles, so that it virtually has the appearance of a solution. The solids content of the dispersion obtained following distillation of the solvent can be varied within wide limits of, for example, 20% to 65% by weight, preferably 30% to 50% by weight and more preferably 33% to 45% by weight.

Excess isocyanate groups present in the prepolymer may be subsequently chain-extended in the aqueous phase by reaction with compounds (D).

The amount of nitrogen-containing, isocyanate-reactive components (D and/or E), preferably polyfunctional component (D) or of a mixture of polyfunctional components (D), is selected such that 45% to 125%, preferably 50% to 105%, and more preferably 55% to 90% by weight of the isocyanate groups are able to be consumed by reaction. The remaining isocyanate groups react with the water present accompanied by chain extension.

Optionally, it is possible, before applying the coating composition containing the polyurethane dispersion of the invention, to add crosslinkers, preferably hydrophilic and hydrophobic polyisocyanate crosslinkers. In the case of 2K (2-component) systems the dispersions of the invention are preferably cured using the known hydrophilic and/or hydrophobic lacquer polyisocyanates. When using lacquer polyisocyanates it may be necessary to dilute them with further quantities of cosolvent in order to achieve effective mixing of the polyisocyanates with the dispersion.

The polyurethane dispersions of the invention are used preferably as binders in physically curing and/or UV-curing coatings and adhesives. Coatings based on the polyurethane dispersions of the invention can be applied to any desired substrates, such as wood, metal, plastic, paper, leather, textiles, felt, glass or mineral substrates, and also to substrates that have already been coated. One particularly preferred application is the coating of wooden floors and plastic floors, especially PVC.

The polyurethane dispersions of the invention can be used as they are or in combination with the additives known from coatings technology, such as fillers, pigments, solvents and flow control assistants, to produce coatings.

The coating compositions containing the polyurethane dispersion of the invention can be applied in known manner, such as by spreading, pouring, knife coating, injecting, spraying (Vakumat), spin coating, rolling or dipping. The coating film can be dried at room temperature or elevated temperature. Where UV-curing constituents are in the dispersions of the invention, the drying operation may further involve irradiation with UV light. Preferably, water and any other solvent is initially removed from the coating by known methods, then irradiation with UV light takes place, and lastly, if appropriate, further drying or curing is carried out.

### EXAMPLES

TABLE 1
Components employed

| Trade name | Designation | Manufacturer |
|---|---|---|
| Desmodur ® W | 4,4′-diisocyanatodicyclo- | Bayer Material- |
| | hexylmethane, trans-trans | Science AG, |
| | content approximately 20% | Leverkusen, DE |
| | by weight | |
| Desmodur ® I | 1-isocyanato-3,3,5,- | Bayer Material- |
| | trimethyl-5- | Science AG, |
| | isocyanatomethylcyclohexane | Leverkusen, DE |
| Desmophen ®C | Polycarbonate | Bayer Material- |
| 2200 | (1,6-hexanediol) | Science AG, |
| | F* 2, Mn 2000 g/mol | Leverkusen, DE |
| Desmophen ®C | Polycarbonate ester | Bayer Material- |
| 1200 | (1,6-hexanediol, -caprolactone) | Science AG, |
| | F* 2, Mn 2000 g/mol | Leverkusen, DE |
| Ebercryl ® | Ditrimethylolpropane | Cytec Surface |
| 140 | tetraacrylate | Specialities, |
| | | Hamburg, DE |
| Ebercryl ® | Bisphenol A diacrylate | Cytec Surface |
| 600 | F* 2, Mn 500 g/mol | Specialities, |
| | | Hamburg, DE |
| Comperlan ® | Coconut fatty acid mono- | Cognis, Düsseldorf, |
| 100 | ethanol amide | DE |

F* = functionality with respect to isocyanates

Polyester Oligomer Precursor

A 5 liter reactor with top-mounted distillation apparatus was charged with 3200 g of castor oil and 1600 g of soya oil and also with 2.4 g of dibutyltin oxide. A stream of nitrogen (5 1/h) was passed through the reactants. Over the course of 140 minutes this mixture was heated to 240° C. After 7 h at 240° C. it was cooled. The OH number was 89 mg KOH/g and the acid number was 2.5 mg KOH/g.

### Example 1

A mixture of 121.6 g of Desmophen® C 2200, 56.1 g of a polycarbonatediol (based on 1,6-hexanediol and 1,4-butanediol (25:75 ratio by weight), Mn 1000 g/mol), 29.1 g of dimethylolpropionic acid, 39.0 g of neopentyl glycol, 1.4 g of butyl glycol and 160.6 g of acetone were heated to 55° C. and stirred. Then 117.9 g of Desmodur® W and 116.6 g of Desmodur® I were added and the mixture was heated to 68° C. It was stirred at this temperature until an NCO content of 3.4% was reached. Thereafter it was cooled to 60° C. and 22.0 g of triethylamine were added. 550 g of this solution were dispersed with vigorous stirring in 546 g of water, which had been introduced at a temperature of 35° C. Dispersion was followed by stirring for 5 minutes. Subsequently, over the course of 10 minutes, a solution of 5.0 g of hydrazine hydrate, 3.0 g of diethylenetriamine and 1.3 g of ethyl-enediamine in 60.7 g of water was added. After it had all been added, the mixture was stirred at 40° C. for 20 minutes, before the acetone was removed by vacuum distillation at this temperature. For complete consumption of the isocyanate groups by reaction, the mixture was stirred at 40° C. until NCO was no longer detected by IR spectroscopy. Cooling to <30° C. was followed by filtration through a 240 μm rapid filter from Erich Drehkopf.

Properties of the Polyurethane Dispersion:

| Average particle size: (laser correlation spectroscopy, LCS) | 29 nm |
|---|---|
| pH (10% solids, 20° C.): | 8.7 |
| Solids content: | 39.0% |
| Weight ratio of IPDI to 4,4′-diisocyanatodicyclohexylmethane: | 50:50 |

### Example 2

277.9 g of Desmophen® C 2200, 27.0 g of dimethylolpropionic acid, 37.9 g of neopentyl glycol, 1.2 g of butyl glycol and 185.3 g of acetone were heated to 55° C. and stirred. Then 37.5 g of Desmodur® W and 174.5 g of Desmodur® I were added and the mixture was heated to 70° C. It was stirred at this temperature until an NCO content of 2.5% was reached. Thereafter it was cooled to 68° C. and 20.3 g of triethylamine were added. 600 g of this solution were dispersed with vigorous stir-ring in 726.0 g of water, which had been introduced at a temperature of 35° C. Dispersion was followed by stirring for 5 minutes. Subsequently, over the course of 10 minutes, a solution of 4.0 g of hydrazine hydrate, 2.4 g of diethylenetriamine and 1.0 g of ethylenediamine in 80.7 g of water was added. After it had all been added, the mixture was stirred at 40° C. for 20 minutes, before the acetone was removed by vacuum distillation at this temperature. For complete consumption of the isocyanate groups by reaction, the mixture was stirred at 40° C. until NCO was no longer detected by IR spectroscopy. Cooling to <30° C. was followed by filtration through a 240 μm rapid filter from Erich Drehkopf.

Properties of the Polyurethane Dispersion:

| Average particle size (LCS): | 38 nm |
|---|---|
| pH (10% solids, 20° C.): | 8.5 |
| Solids content: | 37.4% |
| Weight ratio of IPDI to 4,4′-diisocyanatodicyclohexylmethane: | 82:18 |

### Example 3

152.1 g of Desmodur® W and 348.7 g of Desmodur® I were heated to 55° C. and stirred. Then 62.2 g of dimethylolpropionic acid were added. After 5 minutes a solution of 470.4 g of Desmophen® C 1200, 96.3 g of neopentyl glycol, 2.8 g of butyl glycol and 377.5 g of acetone was added over the course of 20 minutes and the mixture was heated to 68° C. It was stirred at this temperature until an NCO content of 2.8% was reached. Thereafter it was cooled to 60° C. and 46.9 g of triethylamine were added. 450 g of this solution were dispersed with vigorous stirring in 545.9 g of water, which had been introduced at a temperature of 35° C. Dispersion was followed by stirring for 5 minutes. Subsequently, over the course of 10 minutes, a solution of 2.0 g of diethylenetriamine, 1.1 g of n-butylamine and 3.5 g of ethylenediamine in 60.7 g of water was added. After it had all been added, the mixture was stirred at 40° C. for 20 minutes, before the acetone was removed by vacuum distillation at this temperature. For complete consumption of the isocyanate groups by reaction, the mixture was stirred at 40° C. until NCO was no longer detected by IR spectroscopy. Cooling to <30° C. was followed by filtration through a 240 μm rapid filter from Erich Drehkopf.

Properties of the Polyurethane Dispersion:

| Average particle size (LCS): | 25 nm |
|---|---|
| pH (10% solids, 20° C.): | 7.9 |
| Solids content: | 35.9% |
| Weight ratio of IPDI to 4,4′-diisocyanatodicyclohexylmethane: | 70:30 |

### Example 4

### Dispersion Containing Acrylic Groups

71.7 g of Desmodur® W and 163.9 g of Desmodur® I were heated to 55° C. and stirred. Then 29.2 g of dimethylolpropionic acid were added. After 5 minutes a solution of 226.0 g of Desmophen® C 1200, 45.2 g of neopentyl glycol, 1.3 g of butyl glycol and 177.3 g of acetone was added over the course of 20 minutes and the mixture was heated to 68° C. It was stirred at this temperature until an NCO content of 2.8% was reached. Thereafter it was cooled to 40° C. and 22.1 g of triethylamine were added and stirred in for 5 minutes. Subsequently 26.9 g of Ebecryl® 140 were added and stirred in for a further 5 minutes. 760 g of this solution were dispersed with vigorous stirring in 924 g of water, which had been introduced at a temperature of 35° C. Dispersion was followed by stirring for 5 minutes. Subsequently, over the course of 10 minutes, a solution of 4.7 g of diethylenetriamine, 1.7 g of n-butylamine and 4.4 g of ethylenediamine in 102.7 g of water was added. After it had all been added, the mixture was stirred at 40° C. for 20 minutes, before the acetone was removed by vacuum distillation at this temperature. For complete consumption of the isocyanate groups by reaction, the mixture was stirred at 40° C. until NCO was no longer detected by IR spectroscopy. Cooling to <30° C. was followed by filtration through a 240 μm rapid filter from Erich Drehkopf.

Properties of the Polyurethane Dispersion:

| Average particle size (LCS): | 30 nm |
|---|---|
| pH (10% solids, 20° C.): | 8.3 |
| Solids content: | 36.4% |
| Weight ratio of IPDI to 4,4′-diisocyanatodicyclohexylmethane: | 70:30 |

### Example 5

### Dispersion Containing Acrylic Groups

71.7 g of Desmodur® W and 163.9 g of Desmodur® I were heated to 55° C. and stirred. Then 29.2 g of dimethylolpropionic acid were added. After 5 minutes a solution of 226.0 g of Desmophen® C 1200, 39.8 g of neopentyl glycol, 1.3 g of butyl glycol, 26.7 g of Ebecryl® 600, 0.6 g of 2,6-di-tert-butyl-4-methylphenol and 177.3 g of acetone was added over the course of 20 minutes and the mixture was heated to 60° C. It was stirred at this temperature until an NCO content of 2.7% was reached. Thereafter it was cooled to 40° C. and 22.1 g of triethylamine were added and stirred in for 5 minutes. 760 g of this solution were dispersed with vigorous stirring in 924 g of water, which had been introduced at a temperature of 35° C. Dispersion was followed by stirring for 5 minutes. Subsequently, over the course of 10 minutes, a solution of 4.7 g of diethylenetriamine, 1.7 g of n-butylamine and 4.4 g of ethylenediamine in 102.7 g of water was added. After it had all been added, the mixture was stirred at 40° C. for 20 minutes, before the acetone was removed by vacuum distillation at this temperature. For complete consumption of the isocyanate groups by reaction, the mixture was stirred at 40° C. until NCO was no longer detected by IR spectroscopy. Cooling to <30° C. was followed by filtration through a 240 μm rapid filter from Erich Drehkopf.

Properties of the Polyurethane Dispersion:

| Average particle size (LCS): | 42 nm |
|---|---|
| pH (10% solids, 20° C.): | 8.0 |
| Solids content: | 35.5% |
| Weight ratio of IPDI to 4,4′-diisocyanatodicyclohexylmethane: | 70:30 |

### Comparative Example 6

208.6 g of Desmophen® C 1200, 35.1 g of dimethylolpropionic acid, 28.6 g of neopentyl glycol, 2.3 g of Comperlan® C 100 and 171.9 g of acetone were heated to 55° C. and stirred. Then 206.1 g of Desmodur® W and 35.1 g of Desmodur® I were added and the mixture was heated to 68° C. It was stirred at this temperature until an NCO content of 3.6% was reached. Thereafter it was cooled to 60° C. and 22.0 g of ethyldiisopropylamine were added. 600 g of this solution were dispersed with vigorous stirring in 793.4 g of water, which had been introduced at a temperature of 35° C. Dispersion was followed by stirring for 5 minutes. Subsequently, over the course of 10 minutes, a solution of 4.4 g of hydrazine hydrate, 3.9 g of diethylenetriamine and 3.7 g of ethylenediamine in 88.2 g of water was added. After it had all been added, the mixture was stirred at 40° C. for 20 minutes, before the acetone was removed by vacuum distillation at this temperature. For complete consumption of the isocyanate groups by reaction, the mixture was stirred at 40° C. until NCO was no longer detected by IR spectroscopy. Cooling to <30° C. was followed by filtration through a 240 μm rapid filter from Erich Drehkopf. The dispersion was not stable and underwent sedimentation after a short time.

| | |
|---|---|
| Solids content: | 34.0% |
| Weight ratio of IPDI to 4,4′-diisocyanatodicyclohexylmethane: | 15:85 |

### Comparative Example 7

### Analogous to Ex. from DE 4017525

216.7 g of a polyester formed from adipic acid, 1,6-hexanediol and neopentyl glycol (OH number 56 mg KOH/g), 49.5 g of 1,4-butanediol and 150.0 g of acetone were heated to 55° C. and stirred. Then 142.0 g of Desmodur® W and 39.9 g of Desmodur® I were added and the mixture was stirred at 55° C. for 30 minutes. Then 0.1 g of dibutyltin dilaurate was added and the mixture was heated to 70° C. It was stirred at this temperature for 1 h, when a further 200.0 g of acetone were added. It was subsequently stirred at 63° C. for 2 h until an NCO content of 0.7% was reached. Thereafter it was cooled to 50° C. and 200.0 g of acetone were added. The prepolymer, conditioned at 50° C., was then admixed over the course of 5 minutes with 26.4 g of a 40% strength by weight aqueous solution of the Na salt of N-(2-aminoethyl)-2-aminoethanecarboxylic acid and 56.2 g of water. After 15 minutes, 615.0 g of water were added, with vigorous stirring, over the course of 5 minutes. Following complete addition the mixture was stirred for 20 minutes, before the acetone was distilled off in vacuo at 40° C. The dispersion was not stable and underwent sedimentation after one day of storage at room temperature.

Properties of the Polyurethane Dispersion:

| Average particle size: | 756 nm |
|---|---|
| Solids content: | 40% |
| Weight ratio of IPDI to 4,4′-diisocyanatodicyclohexylmethane: | 22:78 |

### Comparative Example 8

216.7 g of a polyester formed from adipic acid, 1,6-hexanediol and neopentyl glycol (OH number 56 mg KOH/g), 41.7 g of 1,4-butanediol, 8.8 g of dimethylolpropionic acid and 150.0 g of acetone were heated to 55° C. and stirred. Then 142.0 g of Desmodur® W and 39.9 g of Desmodur® I were added and the mixture was stirred at 55° C. for 30 minutes. Then 0.1 g of dibutyltin dilaurate was added and the mixture was heated to 63-68° C. Stirring was carried out at this temperature until an NCO content of 2.2% was reached. Thereafter it was cooled to 50° C. and 401.2 g of acetone were added. The prepolymer, conditioned at 50° C., was then admixed over the course of 5 minutes with a solution of 8.7 g of 2-methyl-1,5-pentanediamine and 68.0 g of water. After 15 minutes 6.7 g of triethylamine were added and the mixture was stirred for 10 minutes. Subsequently 612.0 g of water were added, with vigorous stirring, over the course of 5 minutes. Following complete addition the mixture was stirred for 20 minutes, before the acetone was distilled off in vacuo at 40° C. For complete consumption of the isocyanate groups by reaction, the mixture was stirred at 40° C. until NCO was no longer detected by IR spectroscopy. After cooling to <30° C., the dispersion obtained could not be filtered through a 1000 μm rapid filter from Erich Drehkopf.

Properties of the Polyurethane Dispersion:

| Average particle size: (laser correlation spectroscopy, LCS) | 453 nm |
|---|---|
| pH (10% solids, 20° C.): | 9.7 |
| Solids content: | 40.6% |
| Weight ratio of IPDI to 4,4′-diisocyanatodicyclohexylmethane: | 22:78 |

Resistance Tests on the Coatings

Pieces of felt were soaked with coffee solution as per DIN 68861, red wine (alcohol content: min 12% by volume, max 13% by volume) or ethanol (48% form) and placed on the coating for 24 h, covered with a lid. After an exposure time of 24 h the piece of felt was removed and the area was dabbed off and assessed.

The areas exposed to red wine or coffee were subsequently cleaned using a solution (15 ml cleaning concentrate/1 liter water (e.g.: Falterol rinsing and cleaning concentrate, Falter Chemie Krefeld)).

The low-temperature fracture flexibility was determined by storing a coated, flexible substrate at −18° C. for one hour and, immediately after storage, bending it by 90° over the edge of a bench. Assessment was made in accordance with the following scale:

| | |
|---|---|
| 100% | no visible changes |
| 75% | not fractured, only cracks |
| 50% | fractured, isolated cracks (like a broom) |
| 25% | fractured, several cracks |
| 0% | clean fracture |

With sufficient shearing, the dispersion from Example 4 was admixed with 2.5% by weight (based on binder solids) of Irgacure o 500 (photoinitiator, Ciba-Geigy, Lampertheim, D E) and 0.8% by weight (based on binder solids) of BYK® 346 (Byk, Wesel, D E) and dispersion was continued for about 5 minutes. The applied and dried coating (1 h at room temperature) was crosslinked in a UV tunnel (mercury vapor lamp, 5 m/min.).

TABLE 2
Resistance properties of the coating after drying of the coating
material at 20° C. for 24 h, wet film thickness 180 μm.

| | Example | Example | Example | Comparative |
|---|---|---|---|---|
| | 1 | 3 | 4 | Example 6 |
| Coffee resistance | 4 | 4 | 5 | 2 |
| Red wine resistance | 4 | 3 | 4 | 3 |
| Ethanol resistance | 3 | 3 | 3 | 3 |
| Low-temperature | 75% | 100% | 100% | 75% |
| fracture flexibility | | | | |

Scores: 5 corresponds to no change in the film
0 complete discoloration of the substrate

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous polyurethane dispersion that is free from N-methylpyrrolidone and other solvents and wherein the polyurethane comprises the reaction product of
A) a mixture of 25% to 90% by weight of 1-isocyanate-3,3,5,-trimethyl-5-isocyanatomethylcyclohexane (IPDI) and 10% to 75% by weight of 4,4′-diisocyanatodicyclohexylmethane, wherein the preceding percentages are based on the weight of component A), with
B) one or more polyols having average molecular weights (Mn) of 500 to 3000,
C) one or more compounds which have at least one OH— or NH-functional group and contain a carboxyl and/or carboxylate group, wherein at least 50 mol % of the acid groups, based on the total moles of acid incorporated into the polyurethane, are incorporated by dimethylolpropionic acid,
D) one or more polyols and/or polyamines having average molecular weights (Mn) of below 500, and
E) optionally, one or more monoalcohols and/or monoamines.

2. The aqueous polyurethane dispersion of claim 1 wherein the dispersion also contains one or more polyester (meth)arylates F) and one or more photoinitiators G).

3. The aqueous polyurethane dispersion of claim 1 wherein the polyurethane particles have a particle size of ≦120 nm.

4. The aqueous polyurethane dispersions of claim 1 wherein component B) comprises one or more polyesters, polyethers, polyester carbonates or polycarbonates.

5. The aqueous polyurethane dispersion of claim 1 wherein component B) comprises a mixture of one or more polyesters and one or more polycarbonates.

6. The aqueous polyurethane dispersion of claim 1 wherein component C) consists of dimethylolpropionic acid.

7. The aqueous polyurethane dispersion of claim 2 wherein polyester(meth)acrylates F) contain one or more hydroxyl groups and are chemically incorporated into the polyurethane.

8. A process for preparing the aqueous polyurethane dispersion according to claim 1 which comprises i) reacting components (B), (C), (D) and optionally (E), separately in any order or as a mixture, with component (A), to form a prepolymer, which is present as a solution in a solvent, ii) neutralizing component C), before, during or after dispersing the prepolymer in water, and iii) dispersing the prepolymer in water and removing the solvent by distillation.

9. A coating or adhesive prepared from the aqueous polyurethane dispersion of claim 1.

10. A wood or plastic substrate coated with the aqueous polyurethane dispersion of claim 1.
